(19) United States
(12) Patent Application Publication
(10) Pub. No.: US 2026/0081703 A1
(43) Pub. Date: Mar. 19, 2026

(54) METHOD AND APPARATUS FOR PERFORMING EQUIPMENT-FREE RECEIVE GAIN MEASUREMENT

(71) Applicant: MEDIATEK INC., Hsinchu City (TW)

(72) Inventors: Yu-Lin Hsieh, Hsinchu City (TW); Shih-An Yang, Hsinchu City (TW); Narayanan Baskaran, San Jose, CA (US)

(73) Assignee: MEDIATEK INC., Hsinchu City (TW)

(21) Appl. No.: 19/319,764

(22) Filed: Sep. 5, 2025

Related U.S. Application Data
(60) Provisional application No. 63/696,412, filed on Sep. 19, 2024.

(51) Int. Cl. H04B 17/13

(52) U.S. Cl. CPC H04B 17/13

(57) ABSTRACT

A wireless communication device includes a transmit (TX) chain, a loopback path, a receive (RX) chain, a power detector circuit, and a processing circuit. The TX chain generates a TX signal according to a digital TX input. The loopback path is coupled between an output node of the TX chain and an input node of the RX chain, and loops back the TX signal generated from the TX chain to output an RX signal to the RX chain. The RX chain receives the RX signal from the loopback path, and generates a digital RX output according to the RX signal. The power detector circuit performs power detection upon the RX signal at the input node of the RX chain to generate a power detection output. The processing circuit measures an RX gain of the wireless communication device according to at least the power detection output and the digital RX output.

### CROSS REFERENCE TO RELATED APPLICATIONS

This application claims the benefit of U.S. Provisional Application No. 63/696,412, filed on September 19, 2024. The content of the application is incorporated herein by reference.

### BACKGROUND

The present invention relates to a calibration scheme, and more particularly, to a method and apparatus for performing equipment-free RX gain measurement with the aid of a loopback path and a power detector circuit.

A wireless communication device may include a transmit (TX) chain for dealing with transmission of a radio-frequency (RF) signal over the air, and may further include a receive (RX) chain for dealing with receiving of an RF signal transmitted over the air. For example, the wireless communication device may be a user equipment (UE) in a wireless communication system. In some applications, the UE needs to provide measurement reports to a base station (BS). For example, the measurement reports may include a Reference Signal Received Power (RSRP) measurement report. Calculation of the RSRP may be based on an RX gain. Thus, there is a need for an efficient and cost-effective scheme to measure an RX gain of a wireless communication device during RX calibration.

### SUMMARY

One of the objectives of the claimed invention is to provide a method and apparatus for performing equipment-free RX gain measurement with the aid of a loopback path and a power detector circuit.

According to a first aspect of the present invention, an exemplary wireless communication device is disclosed. The exemplary wireless communication device includes a TX chain, a loopback path, an RX chain, a power detector circuit, and a processing circuit. The TX chain is configured to generate a TX signal according to a digital TX input. The loopback path is coupled between an output node of the TX chain and an input node of the RX chain, and is configured to loop back the TX signal generated from the TX chain to output an RX signal to the RX chain. The RX chain is configured to receive the RX signal from the loopback path, and generate a digital RX output according to the RX signal. The power detector circuit is configured to perform power detection upon the RX signal at the input node of the RX chain to generate a power detection output. The processing circuit is configured to measure an RX gain of the wireless communication device according to at least the power detection output and the digital RX output.

According to a second aspect of the present invention, an exemplary RX gain measurement method is disclosed. The exemplary RX gain measurement method includes: enabling a loopback path between an output node of a TX chain and an input node of an RX chain, and applying a digital TX input to the TX chain, wherein a TX signal generated from the TX chain is looped back to serve as an RX signal of the RX chain through the loopback path; reading a digital RX output of the RX chain; enabling a power detector circuit to perform power detection upon the RX signal at the input node of the RX chain, and reading a power detection output from the power detector circuit; and measuring an RX gain according to at least the power detection output and the digital RX output.

According to a third aspect of the present invention, an exemplary non-transitory machine readable medium storing a program code is disclosed. When executed by a processor, the program code instructs the processor to perform following operations: enabling a loopback path between an output node of a TX chain and an input node of an RX chain, and applying a digital TX input to the TX chain, wherein a TX signal generated from the TX chain is looped back to serve as an RX signal of the RX chain through the loopback path; reading a digital RX output of the RX chain; enabling a power detector circuit to perform power detection upon the RX signal at the input node of the RX chain, and reading a power detection output from the power detector circuit; and measuring an RX gain according to at least the power detection output and the digital RX output.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a wireless communication device that supports the proposed equipment-free RX gain measurement scheme according to an embodiment of the present invention.

FIG. 2 is a flowchart of a first equipment-free RX gain measurement method according to an embodiment of the present invention.

FIG. 3 is a flowchart of a second equipment-free RX gain measurement method according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

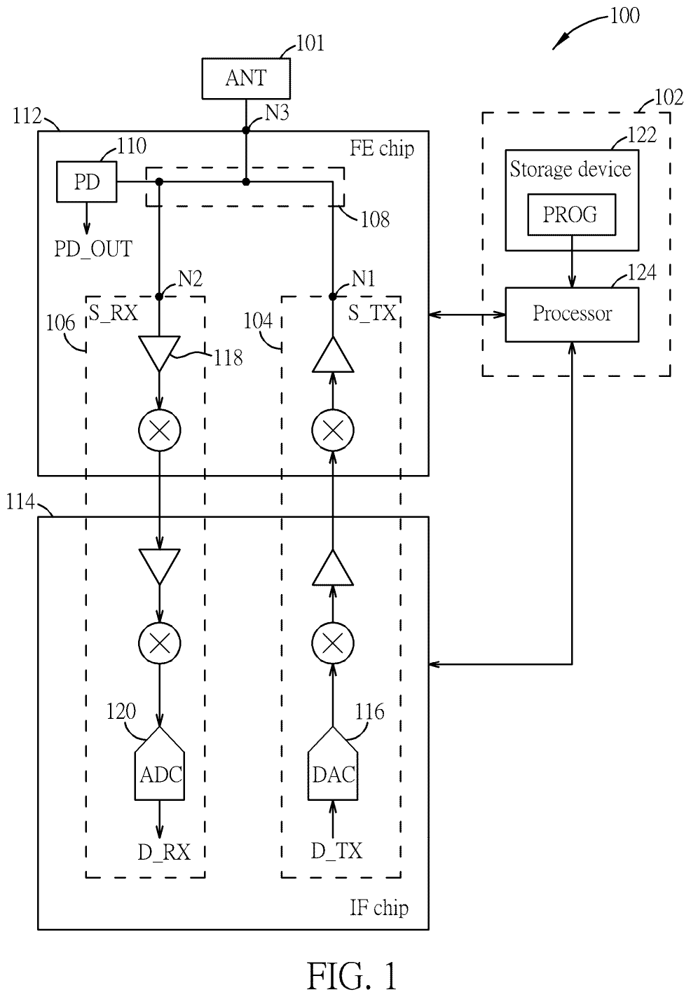

FIG. 1 is a diagram illustrating a wireless communication device that supports the proposed equipment-free RX gain measurement scheme according to an embodiment of the present invention. By way of example, but not limitation, the wireless communication device 100 may be a UE of a wireless communication system. When the wireless communication device 100 operates in a calibration mode, it is capable of measuring an RX gain without using any external measurement equipment. As shown in FIG. 1, the wireless communication device 100 may include an antenna (labeled by “ANT”) 101, a processing circuit 102, a TX chain 104, an RX chain 106, a loopback path 108, a power detector circuit (labeled by “PD”) 110. The loopback path 108 and the power detector circuit 110 may be included in a frontend (FE) chip 112. The TX chain 104 may include some components included in one chip (e.g., FE chip 112) and some components included in another chip (e.g., intermediate-frequency (IF) chip 114). For example, a digital-to-analog converter (DAC) 116 of the TX chain 104 is included in the IF chip 114. The RX chain 106 may include some components included in one chip (e.g., FE chip 112) and some components included in another chip (e.g., IF chip 114). For example, a low-noise amplifier (LNA) 118 of the RX chain 106 is included in the FE chip 112, and an analog-to-digital converter (ADC) 120 is included in the IF chip 114.

In this embodiment, the processing circuit 102 is configured to manage an RX calibration procedure (which includes RX gain measurement) when the wireless communication device 100 operates under a calibration mode. As shown in FIG. 1, the processing circuit 102 includes a storage device 122 and a processor 124. The storage device 122 is a machine readable medium configured to store a program code PROG. For example, the storage device 122 may be a memory device. For another example, the storage device 122 may be any component with data storage capability. When loaded and executed by the processor 124, the program code PROG instructs the processor 124 to deal with operations for RX gain measurement. Further details of the proposed equipment-free RX gain measurement scheme are described as below with reference to the accompanying flowcharts.

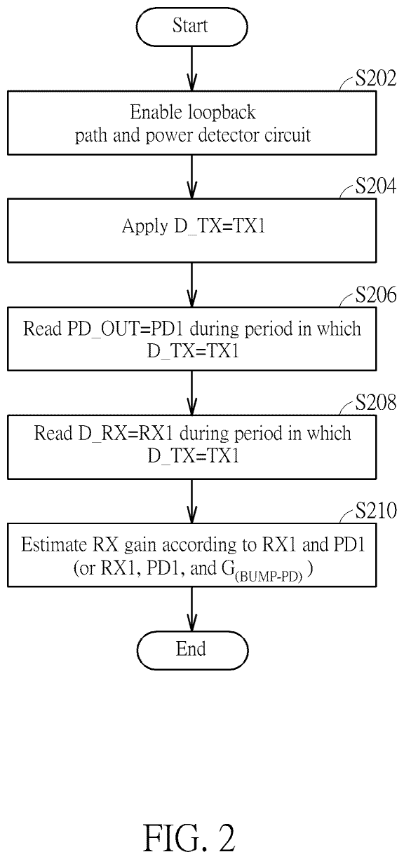

Please refer to FIG. 2 in conjunction with FIG. 1. FIG. 2 is a flowchart of a first equipment-free RX gain measurement method according to an embodiment of the present invention. An RX gain measurement procedure may be managed by the program code PROG running on the processor 124. Provided that the result is substantially the same, the steps are not required to be executed in the exact order shown in FIG. 2. In step S202, the loopback path 108 and the power detection circuit 110 are both enabled by the program code PROG running on the processor 124. The loopback path 108 is coupled between an output node N1 of the TX chain 104 and an input node N2 of an RX chain 106. After the loopback path 108 is enabled, it loops back a TX signal S_TX generated from the TX chain 104 to output an RX signal S_RX to the RX chain 106. That is, the RX signal S_RX needed for RX gain measurement is not received from the antenna 101.

After the power detection circuit 110 is enabled, it performs power detection upon the RX signal S_RX at the input node N2 of the RX chain 106 to generate a power detection output PD_OUT. In this embodiment, the input node N2 of the RX chain 106 is an input node of a first stage amplifier circuit of the RX chain 106. For example, the first stage amplifier circuit may be the LNA 118 of the RX chain 106.

In step S204, the program code PROG running on the processor 124 applies a digital TX input D_TX to the DAC 116 of the TX chain 104. For example, the digital TX input D_TX is set by a TX value TX1. During a period in which the digital TX input D_TX is set by one TX value TX1, the TX chain 104 generates the TX signal S_TX according to the digital TX input D_TX=TX1. In this embodiment, the TX signal S_TX may be a single-tone signal (i.e., a sinusoidal wave) with amplitude/power set the digital TX input D_TX=TX1. The TX signal S_TX loops back through the loopback path 108. In other words, during the period in which the digital TX input D_TX is set by one TX value TX1, the RX signal S_RX is generated due to loopback of the TX signal S_TX, and is not received from the antenna 101.

In step S206, the program code PROG running on the processor 124 reads the power detection output PD_OUT from the power detector circuit 110. For example, during the period in which the digital TX input D_TX is set by one TX value TX1, a power detection value PD1 is provided from the power detection output PD_OUT.

In step S208, the program code PROG running on the processor 124 reads a digital RX output D_RX of the ADC 120 in the RX chain 106. The RX chain 106 generates the digital RX output D_RX according to the RX signal S_RX. For example, during the period in which the digital TX input D_TX is set by one TX value TX1, a digital RX value RX1 is provided from the digital RX output D_RX.

In step S210, the program code PROG running on the processor 124 measures an RX gain G_{RX(PD-ADC)} of the RX chain 106 according to at least the power detection output PD_OUT and the digital RX output D_RX. For example, the program code PROG running on the processor 124 estimates the RX gain G_{RX(PD-ADC)} according to the power detection value PD1 (which is indicative of tone power at an input node of the LNA 118) and the digital RX value RX1 (which is indicative of tone power at an output node of the ADC 120) that are obtained during the period in which the digital TX input D_TX is set by one TX value TX1.

In some embodiments of the present invention, the program code PROG running on the processor 124 may measure an RX gain G_{RX(BUMP-ADC)} of the wireless communication device 100 according to the power detection output PD_OUT, the digital RX output D_RX, and a pre-determined gain value G_{(BUMP-PD)} between the input node N2 of the RX chain 106 and a silicon bump N3 of the FE chip 112 (step S210). The input node N2 of the RX chain 106 is an internal node of the FE chip 112. The pre-determined gain value G_{(BUMP-PD)} may be the same for all FE chips 112, and may be measured using any feasible means before the RX gain measurement procedure shown in FIG. 2 starts. During the period in which the digital TX input D_TX is set by one TX value TX1, the program code PROG running on the processor 124 estimates the RX gain G_{RX(PD-ADC)} of the RX chain 106 according to the power detection value PD1 (which is indicative of tone power at an input node of the LNA 118) and the digital RX value RX1 (which is indicative of tone power at an output node of the ADC 120), and then obtains the RX gain G_{RX(BUMP-ADC)} of the wireless communication device 100 by adding the pre-determined gain value G_{(BUMP-PD)} to the RX gain G_{RX(PD-ADC)} of the RX chain 106 (i.e., G_{RX(BUMP-ADC)}=G_{RX(PD-ADC)}+G(BUMP-PD)).

Considering a case where the power detector circuit 110 is capable of detecting weak tone power, the power detector circuit 110 and the ADC 120 may measure tone power during the same period in which the digital TX input D_TX is set by one TX value TX1. However, this is for illustrative purposes only, and is not meant to be a limitation of the present invention. Considering another case where the power detector circuit 110 is incapable of detecting weak tone power, the power detector circuit 110 and the ADC 120 may measure tone power during multiple periods, respectively.

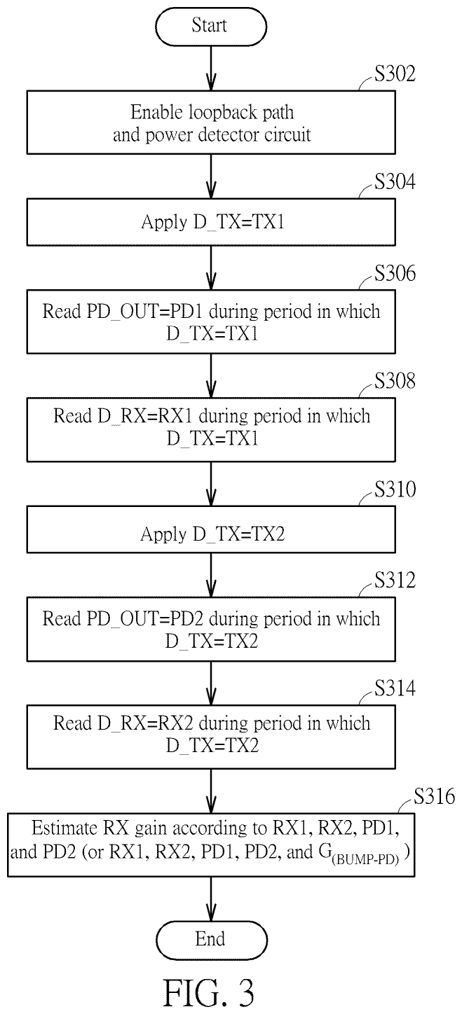

Please refer to FIG. 3 in conjunction with FIG. 1. FIG. 3 is a flowchart of a second equipment-free RX gain measurement method according to an embodiment of the present invention. An RX gain measurement procedure may be managed by the program code PROG loaded and executed by the processor 124. Provided that the result is substantially the same, the steps are not required to be executed in the exact order shown in FIG. 3. In step S302, the loopback path 108 and the power detection circuit 110 are both enabled by the program code PROG running on the processor 124. The loopback path 108 is coupled between the output node N1 of the TX chain 104 and the input node N2 of the RX chain 106. After the loopback path 108 is enabled, it loops back the TX signal S_TX generated from the TX chain 104 to output the RX signal S_RX to the RX chain 106. That is, the RX signal S_RX needed for RX gain measurement is not received from the antenna 101.

After the power detection circuit 110 is enabled, the power detection circuit 110 performs power detection upon the RX signal S_RX at the input node N2 of the RX chain 106 to generate the power detection output PD_OUT. In this embodiment, the input node N2 of the RX chain 106 is an input node of a first stage amplifier circuit of the RX chain 106. For example, the first stage amplifier circuit may be the LNA 118 of the RX chain 106.

In step S304, the program code PROG running on the processor 124 applies a digital TX input D_TX to the DAC 116 of the TX chain 104. For example, the digital TX input D_TX is set by a TX value TX1. During a first period in which the digital TX input D_TX is set by the TX value TX1, the TX chain 104 generates the TX signal S_TX according to the digital TX input D_TX=TX1. In this embodiment, the TX signal S_TX may be a single-tone signal (i.e., a sinusoidal wave) with amplitude/power set the digital TX input D_TX=TX1. The TX signal S_TX loops back through the loopback path 108. In other words, during the first period in which the digital TX input D_TX is set by one TX value TX1, the RX signal S_RX is generated due to loopback of the TX signal S_TX, and is not received from the antenna 101.

In step S306, the program code PROG running on the processor 124 reads the power detection output PD_OUT from the power detector circuit 110. For example, during the first period in which the digital TX input D_TX is set by the TX value TX1, a power detection value PD1 is provided from the power detection output PD_OUT.

In step S308, the program code PROG running on the processor 124 reads a digital RX output D_RX of the ADC 120 in the RX chain 106. The RX chain 106 generates the digital RX output D_RX according to the RX signal S_RX. For example, during the first period in which the digital TX input D_TX is set by one TX value TX1, a digital RX value RX1 is provided from the digital RX output D_RX.

In step S310, the program code PROG running on the processor 124 applies the digital TX input D_TX to the DAC 116 of the TX chain 104. For example, the digital TX input D_TX is set by another TX value TX2 (e.g., TX2<TX1). During a second period in which the digital TX input D_TX is set by the TX value TX2, the TX chain 104 generates the TX signal S_TX according to the digital TX input D_TX=TX2. In this embodiment, the TX signal S_TX may be a single-tone signal (i.e., a sinusoidal wave) with amplitude/power set the digital TX input D_TX=TX2. The TX signal S_TX loops back through the loopback path 108. In other words, during the second period in which the digital TX input D_TX is set by the TX value TX2, the RX signal S_RX is generated due to loopback of the TX signal S_TX, and is not received from the antenna 101.

In step S312, the program code PROG running on the processor 124 reads the power detection output PD_OUT from the power detector circuit 110. For example, during the second period in which the digital TX input D_TX is set by the TX value TX2, a power detection value PD2 is provided from the power detection output PD_OUT.

In step S314, the program code PROG running on the processor 124 reads a digital RX output D_RX of the ADC 120 in the RX chain 106. For example, during the second period in which the digital TX input D_TX is set by one TX value TX2, a digital RX value RX2 is provided from the digital RX output D_RX.

In step S316, the program code PROG running on the processor 124 measures an RX gain G_{RX(PD-ADC)} of the RX chain 106 according to at least the power detection output PD_OUT and the digital RX output D_RX. For example, the program code PROG running on the processor 124 estimates the RX gain G_{RX(PD-ADC)} according to the power detection value PD1 (which is indicative of tone power at an input node of the LNA 118 during the first period in which the digital TX input D_TX is set by the TX value TX1), the power detection value PD2 (which is indicative of tone power at an input node of the LNA 118 during the second period in which the digital TX input D_TX is set by the TX value TX2), the digital RX value RX1 (which is indicative of tone power at an output node of the ADC 120 during the first period in which the digital TX input D_TX is set by the TX value TX1), and the digital RX value RX2 (which is indicative of tone power at an output node of the ADC 120 during the second period in which the digital TX input D_TX is set by the TX value TX2). Specifically, measurement of the RX gain G_{RX(PD-ADC)} may be based on a difference between two power detection values PD1 and PD2 and a difference between two digital RX values RX1 and RX2.

In some embodiments of the present invention, the program code PROG running on the processor 124 measures an RX gain G_{RX(BUMP-ADC)} of the wireless communication device 100 according to the power detection output PD_OUT, the digital RX output D_RX, and the pre-determined gain value G_{(BUMP-PD)} between the input node N2 of the RX chain 106 and the silicon bump N3 of the FE chip 112. The input node N2 of the RX chain 106 is an internal node of the FE chip 112. The pre-determined gain value G_{(BUMP-PD)} may be the same for all FE chips 112, and may be measured using any feasible means before the RX gain measurement procedure shown in FIG. 3 starts. The program code PROG running on the processor 124 estimates the RX gain G_{RX(PD-ADC)} of the RX chain 106 according to the power detection value PD1 (which is indicative of tone power at an input node of the LNA 118 during the first period in which the digital TX input D_TX is set by the TX value TX1), the power detection value PD2 (which is indicative of tone power at an input node of the LNA 118 during the second period in which the digital TX input D_TX is set by the TX value TX2), the digital RX value RX1 (which is indicative of tone power at an output node of the ADC 120 during the first period in which the digital TX input D_TX is set by the TX value TX1), and the digital RX value RX2 (which is indicative of tone power at an output node of the ADC 120 during the second period in which the digital TX input D_TX is set by the TX value TX2), and then obtains the RX gain G_{RX(BUMP-ADC)} of the wireless communication device 100 by adding the pre-determined gain value G_{(BUMP-PD)} to the RX gain G_{RX(PD-ADC)} of the RX chain 106 (i.e., G_{RX(BUMP-ADC)}=G_{RX(PD-ADC)}+G_{(BUMP-PD)}).

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A wireless communication device comprising:
a transmit (TX) chain, configured to generate a TX signal according to a digital TX input;
a loopback path, coupled between an output node of the TX chain and an input node of a receive (RX) chain, wherein the loopback path is configured to loop back the TX signal generated from the TX chain to output an RX signal to the RX chain;
the RX chain, configured to receive the RX signal from the loopback path, and generate a digital RX output according to the RX signal;
a power detector circuit, configured to perform power detection upon the RX signal at the input node of the RX chain to generate a power detection output; and
a processing circuit, configured to measure an RX gain of the wireless communication device according to at least the power detection output and the digital RX output.

2. The wireless communication device of claim 1, wherein the RX chain comprises:
an analog-to-digital converter (ADC), configured to generate the digital RX output.

3. The wireless communication device of claim 1, wherein the input node of the RX chain is an input node of a first stage amplifier circuit of the RX chain.

4. The wireless communication device of claim 1, wherein the input node of the RX chain is an input node of a low-noise amplifier (LNA) of the RX chain.

5. The wireless communication device of claim 1, wherein the digital TX input comprises a digital TX value, the power detection output comprises a power detection value obtained during a period in which the TX signal is generated according to the digital TX value, the digital RX output comprises a digital RX value obtained during the period in which the TX signal is generated according to the digital TX value, and the processing circuit is configured to measure the RX gain according to the power detection value and the digital RX value.

6. The wireless communication device of claim 1, wherein the processing circuit is configured to measure the RX gain according to the digital TX input, the power detection output, and the digital RX output.

7. The wireless communication device of claim 6, wherein the digital TX input comprises a first TX value and a second TX value, the power detection output comprises a power detection value obtained during one period in which the TX signal is generated according to the first TX value, the digital RX output comprises a digital RX value obtained during another period in which the TX signal is generated according to the second TX value, and the processing circuit is configured to measure the RX gain according to the first TX value, the power detection value, the second TX value, and the digital RX value.

8. The wireless communication device of claim 1, wherein the input node of the RX chain is an internal node of a chip, and the processing circuit is configured to measure the RX gain according to at least the power detection output, the digital RX output, and a pre-determined gain value between the input node of the RX chain and a silicon bump of the chip.

9. The wireless communication device of claim 1, wherein the processing circuit comprises:
a storage device, configured to store a program code; and
a processor, configured to load and execute the program code to measure the RX gain.

10. A receive (RX) gain measurement method comprising:
enabling a loopback path between an output node of a transmit (TX) chain and an input node of an RX chain, and applying a digital TX input to the TX chain, wherein a TX signal generated from the TX chain is looped back to serve as an RX signal of the RX chain through the loopback path;
reading a digital RX output of the RX chain;
enabling a power detector circuit to perform power detection upon the RX signal at the input node of the RX chain, and reading a power detection output from the power detector circuit; and
measuring an RX gain according to at least the power detection output and the digital RX output.

11. The RX gain measurement method of claim 10, wherein reading the digital RX output of the RX chain comprises:
reading the digital RX output generated from an analog-to-digital converter (ADC) included in the RX chain.

12. The RX gain measurement method of claim 10, wherein the input node of the RX chain is an input node of a first stage amplifier circuit of the RX chain.

13. The RX gain measurement method of claim 10, wherein the input node of the RX chain is an input node of a low-noise amplifier (LNA) of the RX chain.

14. The RX gain measurement method of claim 10, wherein the digital TX input comprises a digital TX value, the power detection output comprises a power detection value obtained during a period in which the TX signal is generated according to the digital TX value, the digital RX output comprises a digital RX value obtained during the period in which the TX signal is generated according to the digital TX value, and measuring the RX gain according to at least the power detection output and the digital RX output comprises:
measuring the RX gain according to the power detection value and the digital RX value.

15. The RX gain measurement method of claim 10, wherein measuring the RX gain according to at least the power detection output and the digital RX output comprises:
measuring the RX gain according to the digital TX input, the power detection output, and the digital RX output.

16. The RX gain measurement method of claim 15, wherein the digital TX input comprises a first TX value and a second TX value, the power detection output comprises a power detection value obtained during one period in which the TX signal is generated according to the first TX value, the digital RX output comprises a digital RX value obtained during another period in which the TX signal is generated according to the second TX value, and measuring the RX gain according to the digital TX input, the power detection output, and the digital RX output comprises:
measuring the RX gain according to the first TX value, the power detection value, the second TX value, and the digital RX value.

17. The RX gain measurement method of claim 10, wherein the input node of the RX chain is an internal node of a chip, and measuring the RX gain according to at least the power detection output and the digital RX output comprises:
measuring the RX gain according to at least the power detection output, the digital RX output, and a pre-determined gain value between the input node of the RX chain and a silicon bump of the chip.

18. A non-transitory machine readable medium storing a program code, wherein when executed by a processor, the program code instructs the processor to perform following operations:
enabling a loopback path between an output node of a transmit (TX) chain and an input node of an RX chain, and applying a digital TX input to the TX chain, wherein a TX signal generated from the TX chain is looped back to serve as an RX signal of the RX chain through the loopback path;
reading a digital RX output of the RX chain;
enabling a power detector circuit to perform power detection upon the RX signal at the input node of the RX chain, and reading a power detection output from the power detector circuit; and
measuring an RX gain according to at least the power detection output and the digital RX output.
